(19) United States
(12) Patent Application Publication
(10) Pub. No.: US 2006/0178816 A1
(43) Pub. Date: Aug. 10, 2006

(54) Methods, articles and computer program products for providing travel directions

(75) Inventors: Fraser John Dickin, Bristol (GB); Weng Wah Loh, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/341,679

(22) Filed: Jan. 30, 2006

(30) Foreign Application Priority Data
Jan. 31, 2005 (GB) 0501878.3

(51) Int. Cl. G01C 21/26

(52) U.S. Cl. 701/207; 701/1; 701/200

(57) ABSTRACT

A method provides travel directions to facilitate travel to destination to a user having a mobile networkable device. Destination data is read with a reader device from a memory tag, the memory tag being a passive device comprising an electronic memory. The memory tag is attached to an article relating to said destination data. Destination data is thereby provided to the mobile networkable device. Travel directions are then derived from said destination data and presented to the user on the mobile networkable device.

### INCORPORATION BY REFERENCE

This application claims priority from British Patent Application No. 0501878.3, the content of which is incorporated by reference herein. As indicated in the text further below, this application also incorporates by reference U.S. Pat. No. 6,942,158

### FIELD OF THE INVENTION

This invention relates to methods and articles for providing travel directions. In certain embodiments the invention relates to use of a printed document that refers to a place, and to use of mobile networkable devices for presenting travel directions.

### BACKGROUND OF THE INVENTION

Documents such as, for example, guides, brochures, catalogues, leaflets and flyers, which relate to a place often include a map and/or directions of how to get to the place. For example, a leaflet describing the attractions at a theme park will normally have route information such as a small map of how to get to the theme park. Similarly, a catalogue or other marketing material relating to, say, a shop may have a map of how to get to the shop.

The maps produced on such documents, by their nature, are usually general purpose since the users of such documents may be people who may wish to travel to the place featured in the document from a wide range of locations.

The user may find the maps too vague to suit his needs, for example a map in a theme park guide may show the position of the theme park on a small-scale map of the country, possibly together with a large-scale map showing the location of the park in relation to the nearest motorway junction. In this case no specific information is provided in the theme park guide on how to get to theme park from where the user of the guide actual is. For example if the theme park is near Birmingham, England and the user is in Glasgow, Scotland then the guide is likely to lack the relevant map or other route information to inform that particular user on how to get to the theme park. The user may wish to travel to the theme park by car but may wish to avoid motorways, therefore, a large-scale map showing the route from the nearest motorway junction is not particularly helpful.

A further problem with known place guides is that the route information printed on the guides may become out of date. Therefore, the guide will need to be reprinted when it is necessary to update the route information. Reprinting the guides will generally be expensive especially if the new route information requires new art work and/or require that the other printed matter on the document be rearranged. The updated guides would need to be redistributed which is an expensive process.

### SUMMARY OF THE INVENTION

According to one aspect of the invention there is provided a method of providing travel directions to facilitate travel to a destination to a user having a mobile networkable device, the method comprising: reading destination data with a reader device from a memory tag, the memory tag being a passive device comprising an electronic memory attached to an article relating to said destination data and thereby providing destination data to said mobile networkable device; deriving travel directions from said destination data; and presenting said travel directions to the user on said mobile networkable device.

### BRIEF DESCRIPTION OF THE DRAWINGS

There now follows by way of example only a detailed description of specific embodiments of the present invention with reference to the accompanying drawings in which

FIG. 1 illustrates, according to an embodiment of the invention, a printed document having a data carrier;

FIG. 2 illustrates, according to an embodiment of the invention, a mobile phone having an integral data carrier reader;

FIG. 3 illustrates, according to an embodiment of the invention, a mobile phone having a non-integral data carrier reader;

FIG. 4 illustrates, according to an embodiment of the invention, a system comprising the mobile phone of FIG. 2 and a server;

FIG. 5 is a flow diagram that illustrates the processing performed by the mobile phone, according to an embodiment of the invention, in the system of FIG. 4;

FIG. 6 illustrates menus displayed on a mobile phone according to an embodiment of the invention;

FIG. 7 illustrates, according to an embodiment of the invention, a series of maps that are presented to a user of a mobile phone as the user progresses on a journey, each map including the position of the mobile phone;

FIG. 8 illustrates, according to an embodiment of the invention, a series of maps that are presented to a user of a mobile phone as the user progresses on a journey, each map including the location of the mobile phone and the location of a destination;

FIG. 9 is a flow diagram, according to an embodiment of the invention, that illustrates the processing performed by the server in the system of FIG. 4;

FIG. 10 illustrates, according to an embodiment of the invention, communications between the mobile phone and the server of the system of FIG. 4, the mobile phone being a cellular mobile phone;

FIG. 11 illustrates, according to an embodiment of the invention, communications between the mobile phone and the server of the system of FIG. 4, the mobile phone being a satellite mobile phone;

FIG. 12 illustrates, according to an embodiment of the invention, communications in a system comprising a mobile phone having a data carrier reader, other mobile phones and a server.

FIG. 13 illustrates, according to an embodiment of the invention, a printed document in the form of a map having one or more data carriers, the one or more data carriers carrying location data on one or more places covered by the area of the map; and

FIG. 14 illustrates, according to an embodiment of the invention, a printed document in the form of a map having one or more data carriers positioned at places on the map, the one or more data carriers carrying location data on the respective places where the data carriers are positioned on the map.

### DETAILED DESCRIPTION OF SPECIFIC EMBODIMENTS OF THE INVENTION

Before describing specific embodiments in detail, aspects of the invention will first be described in more detail. As indicated above, in one aspect, there is described a method of providing travel directions to facilitate travel to a destination to a user having a mobile networkable device, the method comprising: reading destination data with a reader device from a memory tag, the memory tag being a passive device comprising an electronic memory attached to an article relating to said destination data and thereby providing destination data to said mobile networkable device; deriving travel directions from said destination data; and presenting said travel directions to the user on said mobile networkable device.

In this way a user can use their mobile device as a navigational aid. Navigational information is conveyed to the mobile device pursuant to said destination data being read from said article.

The destination data read from the memory tag may comprise the travel directions, which may be in the form of a map, or visual driving directions (e.g. written instructions). The mobile device may provide the travel directions audibly, eg by vocalising the travel directions on a speaker. The mobile device may vocalise the travel directions as well as or instead of displaying the directions on a display screen. It will therefore be appreciated that it is not essential (although it is preferred) that the mobile device have a display screen.

Additionally, or alternatively, the destination data may be conveyed, via said mobile telephone using a wireless telecommunication network, to a remote travel directions server which uses said destination data as a causal link in causing said travel directions to be sent to said mobile telephone via a wireless communication link. Often the wireless communication network for outward transmission of the destination data from the mobile device to the direction server is the same network as the wireless communication link it need not be (eg some mobile telephones/PDAs are equipped to handle Bluetooth/piconet telecommunications as well as cellular telephone links).

The method may further comprise providing the direction server, or mobile device, with position data indicative of the geographical position of the mobile device, using that position data to influence the content of the travel directions so as to ensure their relevance to travelling from the geographical position of the mobile device to said destination. In this way a more bespoke, tailored, map or set of driving directions can be provided to the user. For example, a map displayed on the display screen could have the current position of the mobile device displayed to a peripheral portion of the screen and the destination disposed to the opposite peripheral position of the screen, so that the majority of the screen display relates to information relating to the area between the current position and the destination.

The method may comprise updating the travel directions at a later point in time, using the new position of the mobile telephone to influence the new travel directions. Thus from time to time the map, if it is a map being displayed, can be re-scaled so as to make most use of the display screen to display a relevant area of the environment.

Additionally or alternatively, the travel directions may relate to a local area, local to the geographical position of the mobile telephone, and not necessarily, at any one time, the whole of the route to the destination. For example, a display of only the next 5 miles, or 10 miles, and 20 miles, may be given, possibly with suggested route/directions delineated in some colour (eg coloured red).

It will be appreciated that the directions server, or the mobile device (eg its processor) can be updated from time to time with information, which will affect the travel directions that are generated or selected for display. For example, if news comes in that a major road is closed (for example for a few days for work, or because of an accident), that information can be provided to the processor that determines the displayed travel information (whether that be the directions server or an on-phone processor) and different travel directions/map information may be caused to be displayed, influenced by the new information.

Thus a user can be directed off a motorway, for example, if there is known to be a big delay on the section of that road which they wish to travel.

Specific embodiments of the invention will now be described in more detail.

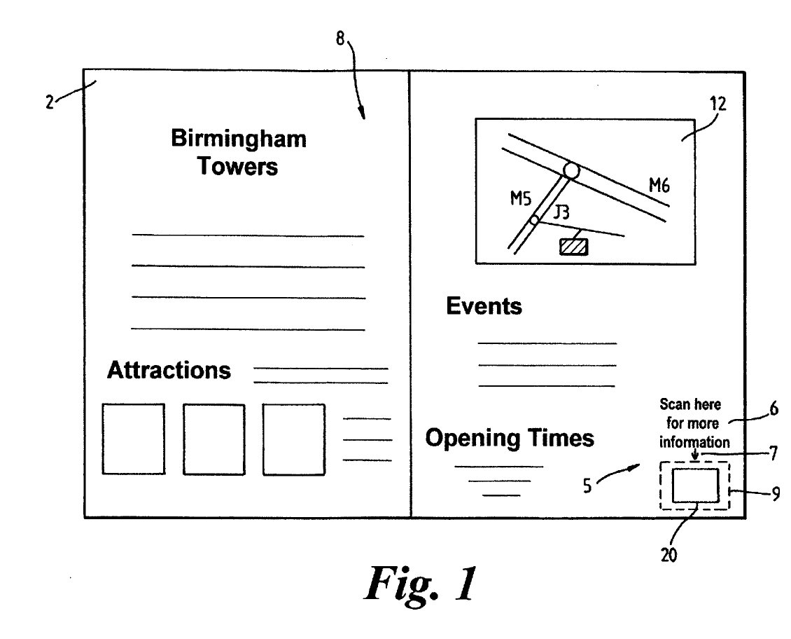

FIG. 1 illustrates a printed document 2, according to an embodiment of the invention. The document 2 may take many forms but generally the document has printed matter 8 including printed matter that refers to a place in some way. The printed matter 8 may include a map 12, for example a large scale map that covers an area limited to the locality of the place or a small scale map showing the location of the place in a large area of country. In this example the document 2 is a brochure advertising an amusement park “Birmingham Towers”, and its purpose is to help to get people to visit the amusement park.

The document 2 incorporates a data carrier 20 that contains either co-ordinate data that gives the location of the place. For ease of illustration the location of the place referred to in the document will be referred to as location ‘B’ in the description and the figures.

The printed document 2 may comprise, for example, one or more sheets of paper, cardboard, plastic or laminated material. The main requirements of the medium of the printed document 2 is that it able to support print or some other human readable markings and be able to support a data carrier 20.

The data carrier 20 is machine-readable and takes the form of a memory tag. A memory tag comprises a passive electronic memory and does not contain a power source. An example of a memory tag is a Radio Frequency Identification (RFID) tag—these are well known in the prior art. RFID tags come in many forms but all comprise an integrated circuit on which in use data can be stored and a coil which enables it to be interrogated by a reader. In some forms of RFID tag the reader also powers the integrated circuit by means of an inductive (wireless) link. Some RFID tags include Read Only Memory (ROM) and are written to at the time of manufacture, whilst others have read and write capability. Conventionally, RFID tags have tended to be used in applications such as file tracking within offices or in place of or in addition to bar codes for product identification and supply chain management.

Embodiments of the invention employ a memory tag 20 that is inductively powered in the same manner as an RFID tag, but which has significantly greater memory capacity. Suitable tags (described below as RF tags) are described in U.S. Pat. No. 6,942,158, the content of which is incorporated by reference herein. The RF tag 20 used in an embodiment of the invention is smaller than conventional RF tags. Typically the RF tag 20 covers an area of about 2 mm² (eg 1.44 mm×1.44 mm square). The RF tag 20 is in the form of a microchip and has a built-in antenna that is the top layer of the chip and is integral with the chip. To read the RF tag 20 it is necessary for a reader 60 to be in close proximity to the RF tag 20, i.e. within a few millimetres of the RF tag 20 (typically about 2 mm), and it is convenient to read the tags by placing the reader 60 in contact with the tag 20 or, for an embedded tag, in contact with the material of the document 2 that covers the tag 20.

The RF tag has a memory, for example a random access memory (RAM) that can store 32 KB of data. The use of a memory that employs a ferroelectric RAM could provide a capacity of about 1 MB. An RF tag may be secured to the surface of the printed document 2 or the tag may be embedded in the printed document 2. The position of the tag 20 may be identified by a visual indication 5 so that the user knows which area of the document 2 he or she needs to apply a tag reader 60 (i.e., bring into close proximity/touch the document) in order to read the tag 20. The visual indication 5 may be in the form of an arrow 7, a legend 6 or graphical indication 9 that demarcates an area of the document having the data carrier 20. Preferably the visual indication 5 comprises a legend 6 that informs a user that further information (e.g. route information) is available if the user applies a reader 60 to a particular area of the document 2.

In an embodiment of the invention data can be written to the memory of the RF tag 20. Typically data can be written to the RF tag 20 at a rate of 10 Mb per second.

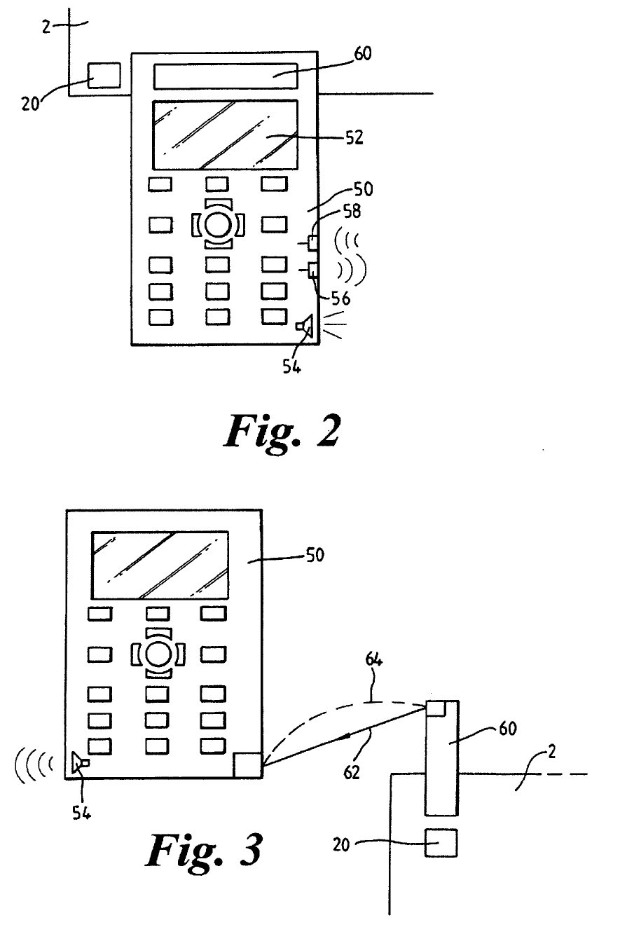

Referring to FIG. 2, a mobile phone 50, according to an embodiment of the invention has an integral reader 60 adapted to read data from the RF tag 20. In this embodiment, the reader 60 can interrogate (read) the RF tag 20.

Alternatively, referring to FIG. 3 the reader 60 may be non-integral with the mobile phone 50 and the reader 60 communicates data read from the RF tag 20 to the mobile phone 50 via a communications link 62, 64. The communications link may be a wired link 62 or a wireless link 64. The wireless link 64 may communicate the data by modulating infra red radiation or by modulating radio wave radiation. For example the mobile phone 50 and the reader 60 may be provided with Bluetooth™ technology which utilises short range radio wave communications.

The reader 50 is generally configured to operate at 2.4 GHz. The RF tag 20 is able to transmit data to the reader 60 at a rate of about 5 Mb per second. Such a high rate of data transfer means that the reader 60 only needs to be brought into contact with the reader 60 for a short time. Therefore, if the RF tag memory contains, for example, 32 KB of information then the entire contents of the memory can be read in a fraction of the time. Even if the memory holds 1 MB (as may be provided by a ferroelectric RAM) of information then the entire contents of the memory could be read in the order of a second.

The reader 60, for both the embodiments (i.e. the embodiments shown in FIGS. 2 and 3) comprises an inductor and a capacitor that form a tuned circuit. The tuned circuit can be inductively coupled to the circuit of the RF tag 20 so that data can pass from the RF tag 20 to the reader 60.

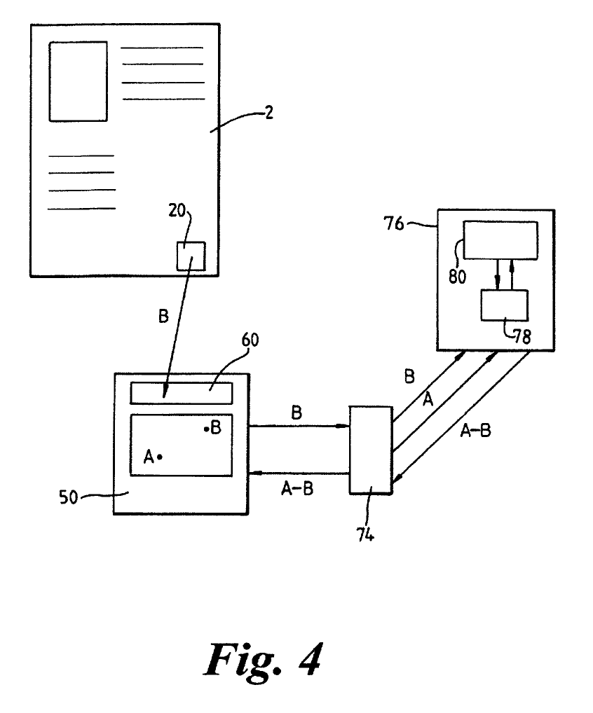

The mobile phone 50 has a transmitter 56 and a receiver 58 that enables the radio wave communications between the mobile phone 50 and a mobile phone network (eg a cellular phone network). FIG. 4 illustrates a system comprising the mobile phone 50, the printed document 2, and a remote server 76. The mobile phone has a processor (not shown). The remote server 76 has a memory 80 (or at least can access a memory) and a processor 78, and communicates with the mobile phone 50 via a communication system 74.

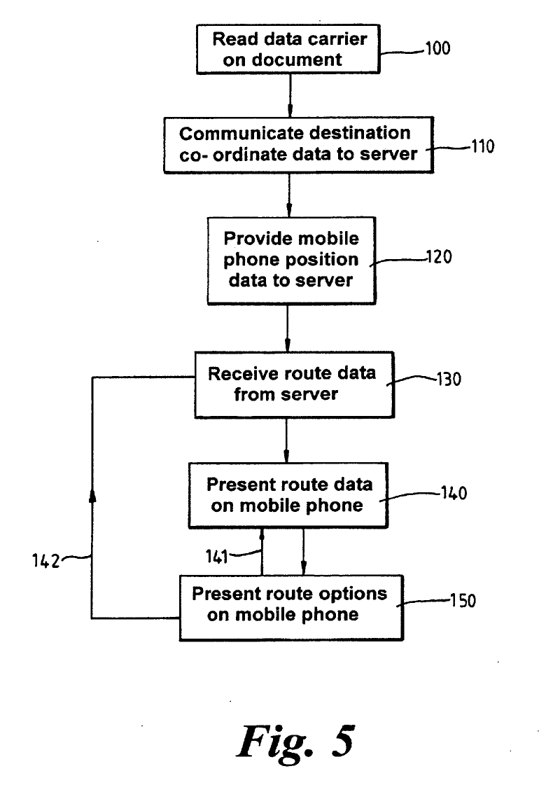

The operation of the mobile phone 50 within the system will now be described with reference to the flow diagram of FIG. 5.

At step 100 the mobile phone 50 uses its reader 60 to read the RF tag 20 on the printed document 2 to obtain co-ordinate data for the location, B, of a place referred to in the printed material 8 on the printed document 2. The location B is the desired destination, or a possible destination, for the user (in the example it is the geographical location of “Birmingham Towers”).

At step 110 the mobile phone 50 communicates the coordinate data of destination location B to the server system 70.

At step 120 the mobile phone 50 transmits a signal that provides the server 70 with information on the location of the mobile phone (described herein as “location A”). This may be done in various ways and will depend on whether the phone is a cellular phone or satellite phone (as will be described hereinbelow). This may be achieved by the act of transmitting a signal to the server 70 that communicates the co-ordinate data relating to the destination location B.

The order of steps 110 and 120 is not important (and they might be the same act); all that is required is that the server 76 is provided with information on the location of the mobile phone A and the location of the destination B.

At step 130 the mobile phone 50 receives route data from the server 76 (via a telecoms link). The map and/or route data being received is dependent on the location of the mobile phone, A, and the location of the destination B and is indicated as “A-B” in FIG. 4.

At step 140 the mobile phone 50 presents the route data to the user. This will usually be done by displaying route data on the display 52 of the mobile phone 50. The route data may consist of, for example, a list of directions that appear on the display 52 or as a route highlighted or otherwise marked on a map on the display 52. The mobile phone 50 will normally be provided with a speaker 54 and the route data may be presented as audio as well as, or instead of, a visual display. For example the mobile phone speaker 54 may pronounce “Turn left at next T-junction”, or whatever. For hands free mobile phone sets the pronouncement may be made over a speaker that is not integral with the mobile phone.

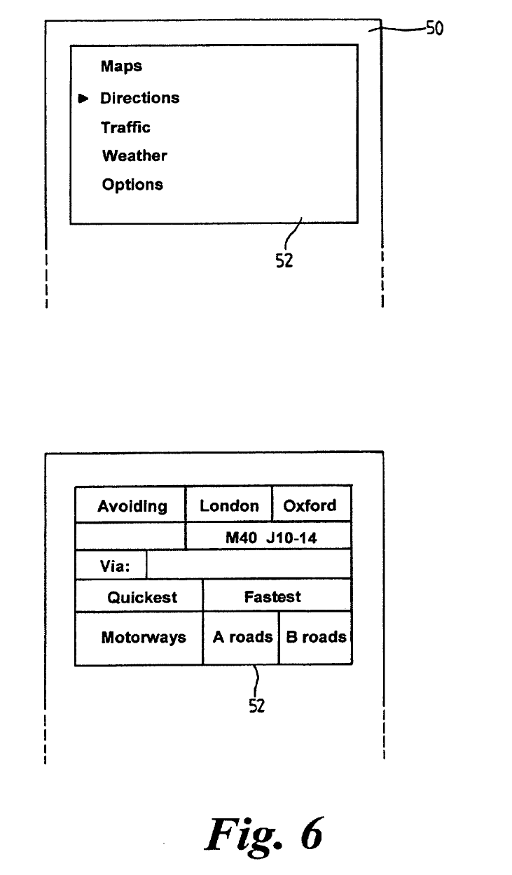

At step 150 the mobile phone 50 may present the user with various options for the route data to be presented. Referring to FIG. 6 the options may be presented on the mobile phone display 52 in the form of a menu. The options may include, for example, one or more of the following:

(i) a zoom in/out function that allows the user to select or change the scale of a map;

(ii) a translation function that allows the user to translate a displayed map to different parts of a route between the location of the mobile phone A (and therefore of the user) and the location of the destination B.

(iii) providing either the quickest or shortest route between A and B;

(iv) providing a route that predominately has a certain type of road (e.g. mainly motorway, trunk roads or minor roads) or a mixture of certain types of road);

(v) providing a route avoiding certain places, e.g. certain towns, certain stretches of road, or certain junctions;

(vi) providing a route that goes via certain places, e.g. certain towns or certain attractions; and

(vii) providing the largest scale map that includes both the location of the mobile phone, A, (and therefore of the user) and the location of the destination B.

After the user selects one or more of the options the mobile phone 50 updates the presentation of the map/route data in accordance with the options chosen.

Step 150 may occur before step 140 or before step 130. That is, instead of the mobile phone 50 initially presenting the route data or even before it retrieves any route data it initially presents the options.

The option menu may be generated by the mobile phone 50. In this case, the option menu that is presented may be the same irrespective of the location A of the mobile phone 50 and the location B of the destination. Alternatively, the server 76 may generate a set of options that are dependent on the mobile phone location A and the destination location B, and then communicates these options to the mobile phone 50 for presentation to the user. For example, if the mobile phone 50 is located on a road that is in the countryside the server 76 may not provide the mobile phone 50 with the option of zooming in to a very large scale map since the mapping information required to produce such a map may not be available, whereas such an option is likely to be available if the mobile phone 50 location was in, for example, a town centre. In another example if there is no sensible route between A and B that involves a motorway (for example because A and B are both distant from a motorway) then the option of presenting map or route information that consists mainly of motorway would not be presented since such a route would be excessively long compared to route that did not use a motorway. Since inappropriate options are not presented to the user the user will find the mobile phone 50 easier to use.

In an embodiment of the invention, the mobile phone 50 may have all the required map/route data from the data initially sent to it by the server 76 (i.e., the map/route data sent by the server 76 in response to receiving the position data for locations A and B) to update the presentation of the route data in accordance with the options chosen. The mobile phone 50 may then process this data to present the updated route data (represented by the arrow labelled 141 in FIG. 5). That is, the mobile phone 50 does not need to receive further map/route data from the server 76 in order to update the map/route data.

In another embodiment, the mobile phone 50 can be configured to communicate the options chosen by the user to the server 76. The server 76 can act on the chosen options to produce updated route data and communicate this updated route data to the mobile phone 50. This will reduce the amount of processing ability and memory capacity required by the mobile phone 50.

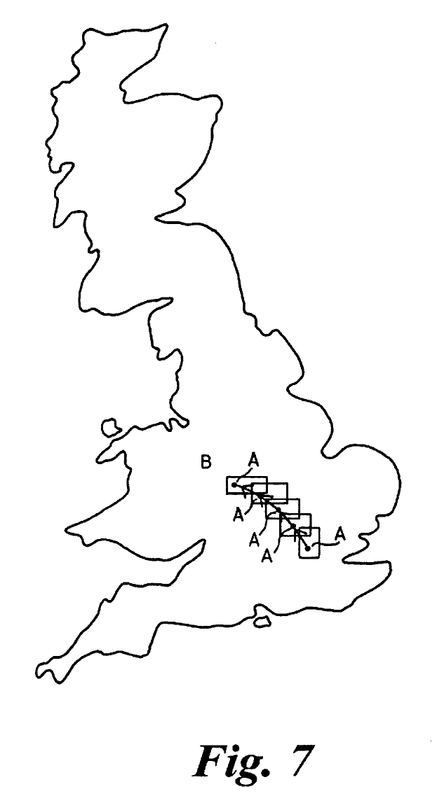

Referring to FIG. 7, the mobile phone 50 may present route data to the user that covers the mobile phone location A and part of the route to the destination location B. That is, the route data does not need to include the destination location B. The route data can be updated periodically as the mobile phone location B changes. In this way a map can be presented to the user that covers an area that is translated across the route between A and B as the user progresses on his journey between A and B.

The updating of the route data can be achieved by the server 76 communicating the updated map/route data to the mobile phone in accordance with the mobile phone location A that is provided to the server 76. Alternatively, the mobile phone 50 processes route data already present in the phones memory (i.e. the route data initially received from the server 76) to produce the updated route data to be presented.

The route data can be updated periodically, for example at regular time intervals or in accordance to how much the mobile phone location A has changed since the route data was last updated. If the mobile phone 50 is located in a town centre then the updated route data may be provided at short time intervals or at short distances (e.g., every 30 seconds or every 100 metres that the mobile phone 50 has moved) whereas if the mobile phone is located on a motorway then the updated map/route data may be provided at longer time intervals or at longer distances (e.g., every 2 minutes or every 4 kilometres that the mobile phone 50 has moved). The frequency of the updates can also be made to be dependant on the speed of the mobile phone 50 as determined by the rate of change of the position of the mobile phone 50. The manner of the updates, i.e. whether they are determined according to time, distance or speed parameters may be pre-selected or selected by the user.

The mobile phone is, typically, connected to a network (switched on) directing the journey and so its position can be determined, and new map/directions data can be sent to it by the remote server 76, if desired.

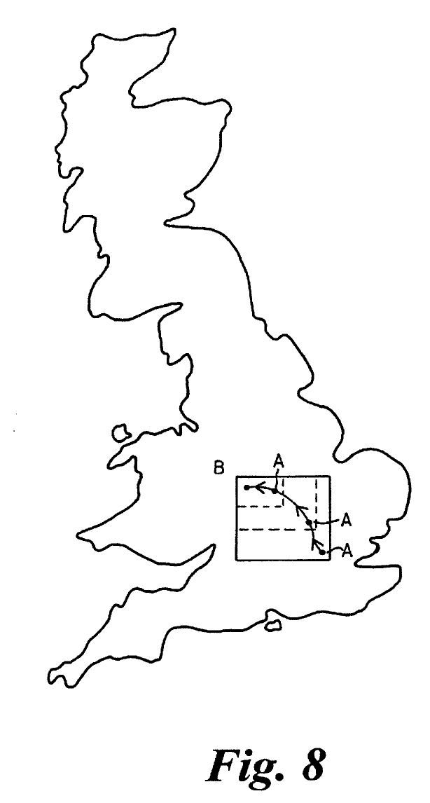

Referring to FIG. 8, another user selectable option is for the mobile phone 50 to present a map to the user that is the largest scale map that covers the mobile phone location A, the destination location B and the route between A and B. In a modification of this option the map that is presented includes a margin of map that surrounds the location A and/or location B (the margin of map being in addition to the area of map covering the route) and/or a margin of map surrounding the route. The size of the area of the country covered by the margin(s) can be an area that is a set as a proportion of the total area of the country displayed by the rest of the map.

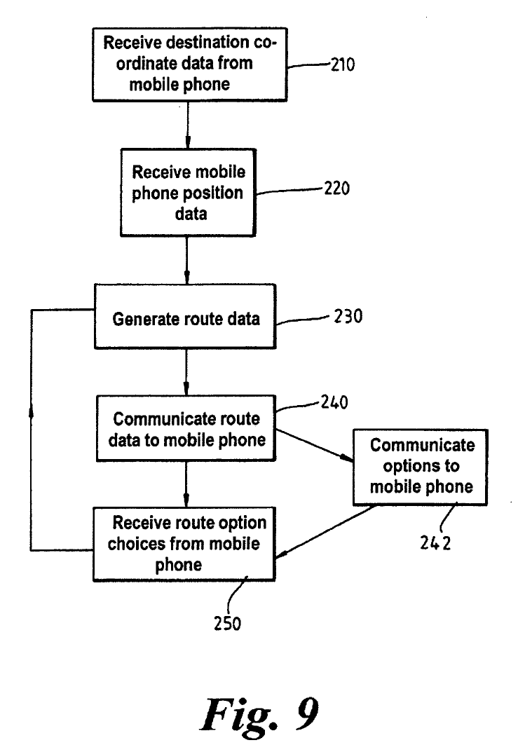

Referring to the flow diagram of FIG. 9, the processes occurring in the server 76 will now be described. At step 210 the server 76 receives co-ordinate data for the destination location B from the mobile phone 50 via the communication system 74. At step 220 the server 76 receives position data on the mobile phone location A via the communication system 74. It does not matter what order steps 210 and 220 occur.

At step 230 the server generates route data, the route data generated being dependent on the position data received in steps 220 and 230. In order to generate the route data the server 76 retrieves the required route data from a memory. The memory 80 may be part of the server 76 or it may be a separate memory, for example a memory that is part of a separate server, or NAS memory.

At step 240 the server 76 communicates the generated route data to the mobile phone 50 via the communication system 74.

At step 250, in an embodiment to the invention, the server 76 receives from the mobile phone 50 route options that have been selected by the user, from the mobile phone 50. The route options that were presented to the user may have been generated by the mobile phone 50 or generated by the server 76 (step 242). The server 76 may generate the options in accordance with the position data for location A and location B.

Following step 250 the server 76 generates route data (i.e., performs step 230 again) based on the options received from the mobile phone and communicates this route data to the mobile phone 50 (i.e., performs step 240 again).

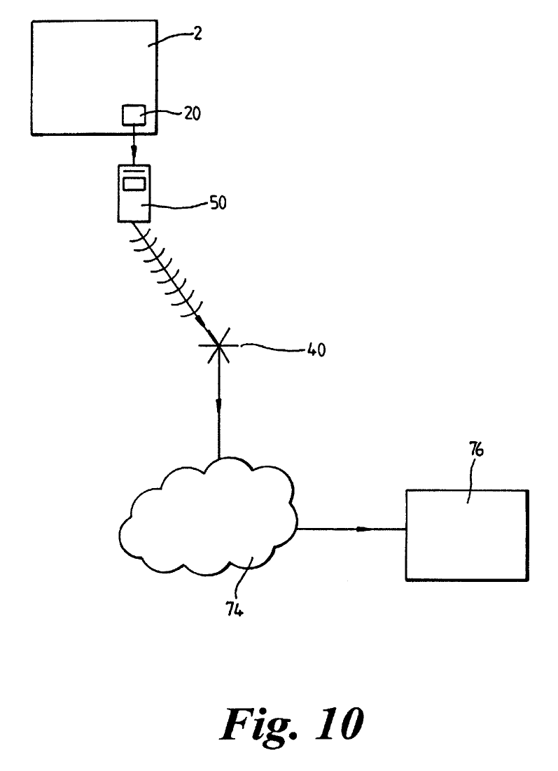

Referring to FIG. 10, for cellular mobile phones, the mobile phone 50 communicates with a base transceiving station 40 of a mobile phone network using radio wave transmissions. The receiving station 40 then communicates with the server 76 via the mobile phone network 74. In this way the mobile phone 50 is able to communicate the coordinates 50 of the destination location to the server 76.

A cellular mobile phone 50 produces periodic radio signals that register the phone 50 with the mobile phone network (these signals are normally produced even when the mobile phone is switched off). The network provider is able to calculate the mobile phone location A using triangulation of the signal strength between the mobile phone 50 and surrounding transceiver base stations. The location of the mobile phone A can be determined with an accuracy of up to 10 meters depending on the number of transceiver stations within range of the radio transmissions from the mobile phone 50. The network provider can therefore communicate the mobile phone coordinates to the server 50.

Cellular mobile phone systems divide a geographic region into portions called cells. Therefore, for a cellular mobile phone, instead of the location of the mobile phone A being provided to the server 76 in the form of co-ordinates the location A could be provided as the identity of a particular mobile phone network cell in which the mobile phone 50 is transmitting. Knowledge of which cell a mobile phone is in is accurate enough information to select, or generate, appropriate relevant directions information (e.g. maps).

Other known protocols may be used to determine the position of the mobile phone 50 including Mobile Positioning Protocol, Spatial Location Protocol and physical positioning technology such as CGI-TA, E-OTD, UL-TDA and A-GPS.

After receiving the position data for location A and location B, the server 76 sends the appropriate route data to the mobile phone 50 using, for example, the same communication system 74 as was used to receive data from the mobile phone 50. Therefore, for cellular mobile phones, the communication system 74 illustrated in FIG. 4 comprise a cellular mobile phone communications network and possibly other elements such as the Internet and/or an intranet such as a local area network (LAN).

Cellular mobile phone systems include analogue systems such as AMPS (Advanced Mobile Phone Service) and digital systems such as, for example, CDMA (Code Division Multiple Access), 3 G, or systems based on the GSM (Global System for Mobile communications) protocols, or on enhancements of such protocols such as the 2.5 G, or GPRS (General Packet Radio Services).

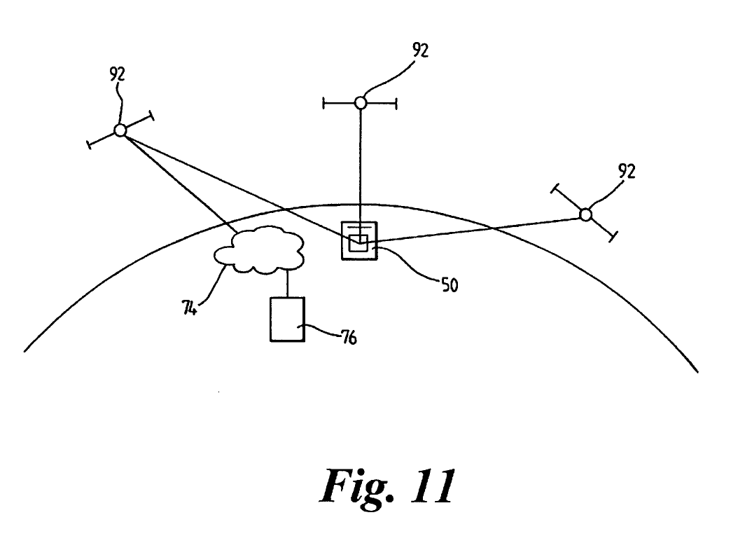

Referring to FIG. 11, satellite mobile phone systems, for example systems based on GPS (Global Positioning System), the mobile phone 50 receives radio signals from a number of satellites 92 (normally three or more satellites). The radio signals are synchronised with an atomic clock on each of the satellites and mobile phone 50 calculates its position on the surface of the earth using the time difference between the receipts of the individual synchronised signals. The satellite mobile phone can be configured to calculate its location and send its location to the server 76.

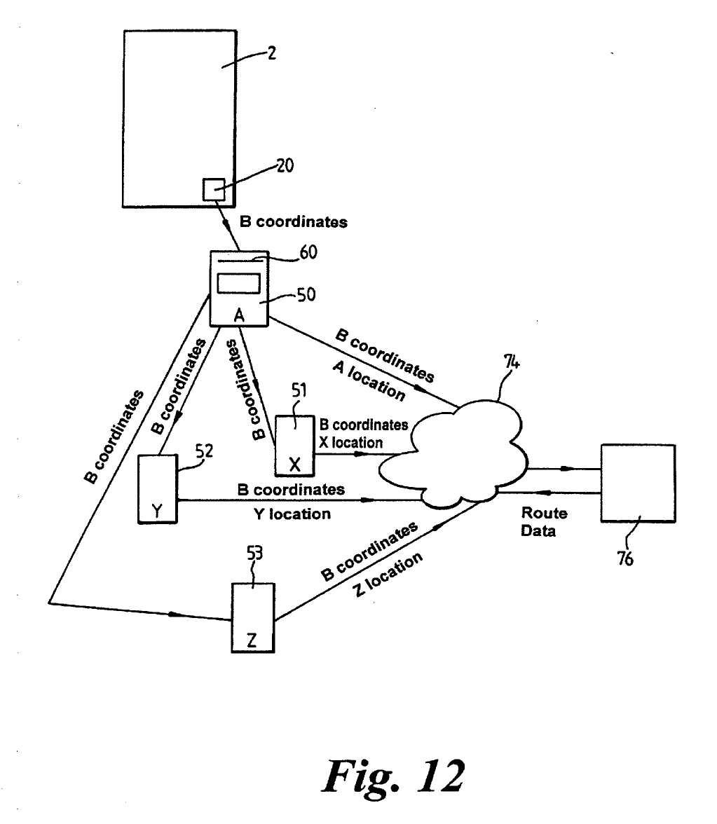

Referring to FIG. 12, coordinates of the destination location B read by the mobile phone 50 can be communicated from the mobile phone 50 to one or more other mobile phones 51, 52, 53. The other mobile phones 51, 52, 53 can then communicate the destination location B to the server 76. locations. The network provider can also communicate the other mobile phone to locations X, Y, Z to the server 76 based on signals transmitted by the other mobile plans 51, 52, 53. In response to receiving this position data the server 76 can send route data to each of the other mobile phones 51, 52, 53. The content of the route data sent to a particular one of the other mobile phones 51, 52, 53 is customised for that mobile phone 51, 52, 53, that is the route data is dependent on the location of that mobile phone 51, 52, 53. In this way if a user wants to meet friends, families, colleagues or other associates at a particular place, the associates will know how to get to that place without needing access to the printed document 2. Also, of course, the other mobile phones 51, 52, 53 do not need to have a RF tag reader 60.

In a variation of this technique the mobile phone 50 that reads the RF tag 20 can communicate both the position data of the destination location B and the telephone numbers of the other mobile phones 51, 52, 53 to a mobile phone network provider and the network provider can communicate the locations X, Y, Z of the other mobile phones 51, 52, 53 to the server 76 (the network provider knowing the positions of the other mobile phones 51, 52, 53 from signals emitted by those mobile phones 51, 52, 53). In this way the other mobile phones 51, 52, 53 can be provided with route data without the respective users of those mobile phones 51, 52, 53 taking any active steps.

In an embodiment of the invention the RF tag 20 carries a unique identification code for a particular location (the ‘destination location’) that can be read by the mobile phone 50. The unique identification code is then communicated to the server 76 in the same way that the coordinate data for the destination location B is communicated in the other above-described embodiments. The server 76 can then look up the coordinates of the destination location B in a memory that holds the coordinates of various locations that have been assigned the unique identification codes. The coordinates of the mobile phone 50 are also communicated to the server 76 so that the server 76 can generate the appropriate route data to be sent to the mobile phone 50.

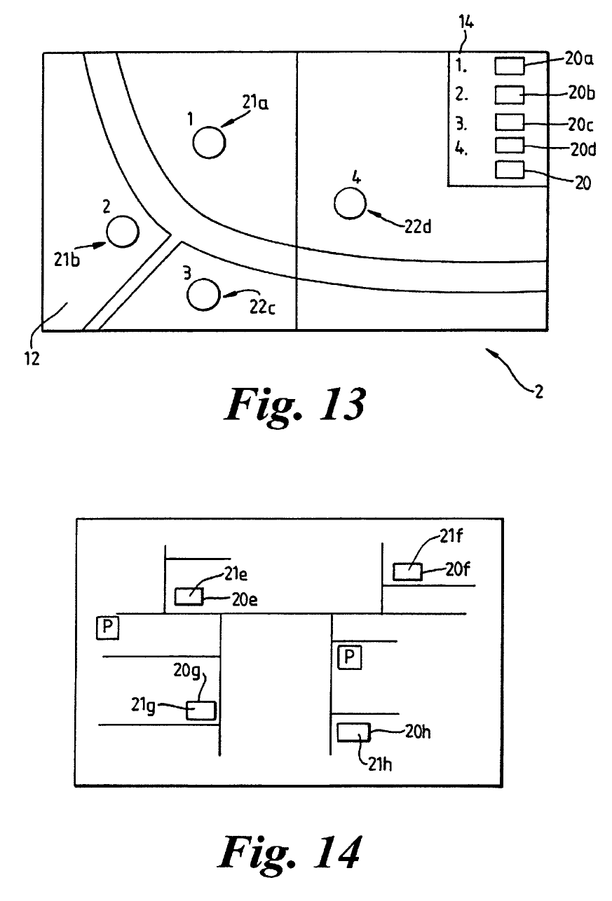

In the example document 2 illustrated in FIG. 1, the document 2 is, as mentioned, an attraction guide for a theme park in the form of a leaflet. Printed on the guide there may be general information on the theme park (e.g. information on various attractions at the theme park, a list of events with times/dates of the events, the opening times of the theme park) and a map 12 of the location of the theme park. However the printed document 2 may take any of a multitude of forms, for example, referring to FIG. 13, the document 2 may take the form of an atlas, street plan, or other form of map 12. The document 2 may then have one or more RF tags 20a, 20b, 20c, 20d each RF tag 20a, 20b, 20c, 20d being associated with a different place on the map 12. The RF tags 20a, 20b, 20c, 20d may be placed in a legend 14 or in a margin of the map 12 and labelled so that they correspond to the corresponding labelled places 21a, 22b, 21c, 21d on the map. In FIG. 13 the labels are Arabic numerals but the labels could take any form (for example a label may be the name of the place labelled).

Instead of having a different RF tag 20a, 20b, 20c, 20d for respective different places on the map, a single RF tag 20 may contain the coordinates or identification data for all the places or a subset of the places labelled on the map 12. For example a particular RF tag 20 may carry all the coordinate data of visitor attractions on the map, whilst another RF tag may carry all the coordinate data for petrol stations shown on the map. When the RF tag 20 is read by the mobile phone 50 the mobile phone 50 will be able to display a list of the various places on which the RF tag 20 has been positioned. The user may then chose the place of interest and the coordinates of that place are then communicated to the server 76 along with the position data of the mobile phone location A and the server 76 provides the mobile phone 50 with route data in accordance with the location of the chosen place and the location of the mobile phone A. The RF tag 20 may also carry label data associated with each set of coordinates so that the mobile phone 50 is able to present labelled places from which the user can chose.

In a variation of this method it is not necessary for the places to be labelled on the map, for example the RF tag may provide the coordinates of all the petrol stations in the area covered by the map 12 or a portion of the map 12 without the petrol stations actually being marked on the map 12. The coordinates of all the petrol stations read by the mobile phone 50 could then be communicated to the server 76 which then communicates appropriate labels to the mobile phone for presentation to the user so that the user may choose a petrol station. The server 76 may be configured to calculate the distance between the mobile phone location and the location of the petrol stations, this information being communicated to the mobile phone 50 for presentation to the user for the user to choose according to when he wants to fill up with petrol. Once the user has made his choice the route data can be presented to the user that is appropriate to that choice.

The server 76 can be configured to communicate additional information associated with a particular place to the mobile phone that the server has obtained from a database. For example, the server may communicate the price of the petrol sold at the petrol station(s) to the mobile phone 50 to present to the user either before or after the user has made his choice.

Other dynamic information can be communicated to the mobile phone 50, e.g. traffic conditions on the route between the mobile phone location A and the location destination B.

Referring to FIG. 14 RF tags 20e, 20f, 20g, 20h may be positioned on the map 12 at positions 21e, 21f, 21g, 21h that correspond to the respective coordinates carried by the RF tags 20e, 20f, 20g, 20h.

The server can provide information for presentation on the mobile phone 50 that is related to the destination but does not relate to the route to the destination. For the example of an attraction guide, once the server 76 has the coordinates or the unique identification code for the attraction (as read by the mobile phone 50 and communicated from the mobile phone 50 to the server 76) the server 76 can send information such as ticket prices and events occurring at the attraction back to the mobile phone 50. It will be appreciated that the information transmitted from the server 76 to the mobile phone 50 can take any form. In this way additional information on the place mentioned in the printed document 2 can be stored on the server 76 and called up by the mobile phone 50. The information held on the server 76 about a particular place can be updated at any time. Therefore the user of the mobile phone can be provided with updated information without needing an updated printed document 2: the same printed document 2 can be used time after time and the user will receive updated information about the place mentioned on the printed document 2 in accordance with the updates to the information held on the server 76.

Additional information to the route data may be held on the RF tag 20. For example the additional information may include a telephone number, e.g. a freephone number or a single or limited use prepaid number that is disabled after it has been used a set number of times. For example if the printed document 2 is an attraction guide then the prepaid phone number may be a phone number on which ticket bookings can be made or on which event details or other information can be given. The telephone number can provide a voice link to an operator or an answering machine. The telephone number could also be used to send text, picture and/or video data to the mobile phone 50. The mobile phone 50 can read the telephone number using the reader 40 and the user merely has to press a call/send button on the mobile phone 50 in order to make the call. Alternatively, the call can be made automatically once the number has been read from the RF tag 20 by the mobile phone 50.

The RF tag 20 may carrier the identity of a web page such as an URL address so that the mobile phone 50 can read the memory tag and be directed to the web-site. For example, the mobile phone 60 may read a URL from the RF tag 20 and the phone 50 can then display the web site or part of the website for that URL on the display 52 of the mobile phone 50. If required, the RF tag 20 can be updated, i.e. overwritten with a new web site address or additional websites addresses written onto the RF tag 20.

In an embodiment of the invention it is not necessary that the mobile phone 50 communicate with the server 76 in order to obtain route information relevant to the location of the mobile phone 50 and the destination. In this case all the required route data is stored in a memory on the mobile phone 50, for example the memory may contain map data for the road system of the entire United Kingdom. This route data can then be processed by a processor on the mobile phone 50 to present route data to the user that is relevant/customised for the user. For example the route data may be processed in accordance with the coordinate data read from the mobile phone 50 from the RF tag 20 and the location of the mobile phone 50 (as determined by the mobile phone 50 from signals received by the mobile phone 50 from a mobile telephone network (e.g. by triangulation from signals received from satellites or radio masts or from a signal that actually contains location data for that mobile phone 50)). Therefore, the route data held on the mobile phone 50 can be processed so only data relevant to the route between the mobile phone location A and the destination location B is presented. The route data presented to the user of the mobile phone 50 can modified in accordance to options presented to the user as has been discussed in relation to other embodiments of the invention.

In a variation of this embodiment the memory tag 20 carries all the required route data (e.g. map data for the road system of the entire United Kingdom) and this data is read by the mobile phone 50 using the reader 60 and stored in a memory on the mobile phone 50. The route data can then be processed on the mobile phone 50 in the same way as has been described above.

In an embodiment of the invention once the mobile phone 50 has route data stored on memory of the phone, by whatever means, the user is able to select a service from a mobile phone operator to enable the user to be sent a personalised route/map of how to reach the destination from his/her current location. The personalisation could include via's or preferences to use of particular types of road etc. The user may be billed by the mobile phone operator according to the service(s) selected by the user.

The telecommunications link between the mobile phone 50 and the remote server 76 need only be temporary. For example, the mobile phone 50 may connect to a telecommunications network just once in order to download a map. The user may then zoom in, zoom out, or show different portions of the map (e.g. scroll through the map) appearing on the mobile phone display 52 using, for example, keys on the mobile phone. For example, it is not necessary to reconnect to the server 76 to get another page or part of the map if all the map data is downloaded from the server during a single connection period (eg during a single “dial up”).

The user may pay a fee to connect to the telecommunications network 74, for example by dialling a particular number, and to receive a relevant map or maps from the server 76. The server generates (and sends) a relevant map based on the location of the destination B (as read from the RF tag 20 by the mobile phone 50) and the mobile phone location A (as determined, for example, by the mobile phone network provider from pings emitted by the mobile phone). If the user makes a detour on the journey from A to B or gets lost then the user may connect to the telecommunications network again to obtain updated route/map data based on the user's new position.

As an example a mobile phone 50 with a display 52 may download a number of maps, for example six maps. The maps downloaded being generated according to the location of the phone A when the maps are requested from the server 76 and the destination location B. The user may simply toggle between maps of successive detail, or successive portions of a journey, by pressing buttons on the mobile phone 50. The user might have to press a “change map” button, the software operating on the mobile phone 50 being configured, for example, so that every time the user presses the “1” key the map moves along a section along the route between A and B. Alternatively, the mobile phone 50 may change the map automatically dependent upon its own position. It will be appreciated that this is just one example of how map information provided in a single connection period (i.e. provided from a single “dial up”) can be utilised.

It will be appreciated devices other than devices that are actual mobile phones can be used. For example the device may not be pocketable. The device may be fitted to a car or other vehicle, for example in a similar way that a satellite navigation system is fitted.

The device may be a PDA (Personal Digital Assistance), palm-sized hand held computer, or lap-top or tablet computer. These all have mobile wireless telecommunications capability.

If the device does not have a graphical display then the route information may be presented in a textual format.

The device does not need to have a screen at all. Instead the device may give audio instructions to a user via a speaker. In this way the audio instructions may ‘talk’ through the route. The entire route may be provided to the device via a single connection (e.g. via a single dial up) so that the user can listen to the entire route before embarking on the journey or the user may select a different part of the route to be vocalised by using keys on the device when directions for a particular part of the route are required. The device may automatically vocalise a section of the route according to the location of the mobile phone A (as determined, for example by a telecommunications network), for example, the device may vocalise “take second exit at next Junction and continue for two kilometres”. In this case the section of the route vocalised may be selected from the entire route as initially downloaded or the device may download the section in response to a further connection of the device to a communications network (e.g. in response to a further dial up). It will be appreciated that the device may have a display and still vocalise directions either instead of or as well as displaying route data on the display.

The device may be provided with voice recognition software so that the user can input data into the device by speaking at the device. For example the user may speak to the device to give the device the user's current position—if the device did not know the user's current position. Or the user may speak to the device to tell the device certain preferences, e.g. for the route to go via certain places or to avoid others or to use mainly motorways etc. The device may then vocalise and/or display route information according to the data spoken to the device.

The device may have a predetermined response for a particular spoken datum for a particular route. For example in response to the user saying “I am on the M6 approaching junction 5” the software will be configured so that the device automatically responds “carry on to junction 8”. Alternatively the response to be vocalised may be generated by software on the device only after receiving spoken data. For example the user may say “I am approaching junction 8 of the M6” and the software could recognise this to generate the reply “leave the motorway at junction 8 and go on the A1001 to Leeds. Carry on for six miles” the reply then being vocalised. The user could then turn off onto that road, and after going three miles the user could say “sign says Harrogate A899 four miles, I am on the A1001”. The software could then use that speech to generate the response “carry on one mile, take turning on left to B665 sign-posted Brown Town”. And so on.

The mobile device may not have a screen but may still have map data stored inside the device, for example as read from the RF tag 20 or downloaded from the server 76. The mobile device is told where it is by a voice-input from the user (instead of by, for example, be the telecommunications network) and will therefore know what part of a route is coming next.

A computer program product may be provided for programming the processor of the mobile phone or the server to carry out any of the steps indicated above. The computer program product may be embodied on a machine readable medium. The machine readable medium may be any one or more of the following: a floppy disk; a CD ROM/RAM; a DVD ROM/RAM (including +R/RW, -R/RW); any form of magneto or optical disk; a hard drive; a memory; a transmitted signal (including an internet download, file transfer, or the like); a wire; or any other form of medium.

While use of printed documents has been described in detail above, aspects of the invention can be applied with other articles besides printed documents. For example a memory tag with destination data may be provided on a souvenir of a place, for example on a key ring or a mug or whatever.

1. A method of providing travel directions to facilitate travel to a destination to a user having a mobile networkable device, the method comprising:
reading destination data with a reader device from a memory tag, the memory tag being a passive device comprising an electronic memory attached to an article relating to said destination data and thereby providing destination data to said mobile networkable device;
deriving travel directions from said destination data; and
presenting said travel directions to the user on said mobile networkable device.

2. A method as claimed in claim 1, wherein the reader device reads data by inductively powering the memory tag.

3. The method of claim 1, wherein said device has a display screen and said presenting comprises displaying said travel directions on said display screen of said mobile networkable device

4. The method of claim 1, wherein said destination data is conveyed to a remote travel directions server via said mobile networkable device using a wireless telecommunications link, said directions server using said destination data as a causal link in causing said travel directions to be sent to said mobile networkable device via a wireless communications link.

5. The method of claim 4 further comprising providing said directions server or mobile networkable device with position data indicative of the geographical position of said mobile networkable device, using that position data to influence the content of said travel directions.

6. The method of claim 5, wherein said travel directions conveyed to the mobile networkable device are tailored to a user of the mobile networkable device using said position data.

7. The method of claim 1, wherein said article is a printed document.

8. An article comprising human readable information relating to a place and a memory tag, being a passive device comprising an electronic memory, attached to the article, the electronic memory of the memory tag containing place position data relating to said place.

9. The article of claim 8, wherein said place position data is data that uniquely identifies said place.

10. The article of claim 8, wherein said place position data comprises co-ordinate data.

11. The article of claim 8, wherein said place position data comprises a unique identification code.

12. The article of claim 8 wherein the memory tag is rewritable.

13. The article of claim 8, wherein the article is a printed document.

14. A computer program product for enabling a processor of a remote server to provide place sensitive information to a mobile networkable device, the computer program product comprising:
code for receiving device position data that locates said device;
code for receiving place position data from said device; and
code for generating route data, said content of said route data being dependent on place position data and said device position data; and
transmitting said route data to said device, wherein the code resides on a tangible medium.

15. A computer program product for enabling a processor of a mobile networkable device to present route data to a user of the mobile networkable device, the computer program product comprising:
code for reading place position data from a data carrier on an article;
code for communicating said place position data to a server;
code for transmitting a signal, said signal providing said server with position data for said location of said device;
code for receiving route data, said route data being generated by said server in dependence on said place position data and said device position data; and
code for presenting said received route data to a user of said device, wherein the code resides on a tangible medium.

16. A computer program product for enabling a processor of a mobile networkable device to present route data to a user of the mobile networkable device, the computer program product comprising:
code for reading place position data from a memory tag, being a passive device comprising an electronic memory, on an article;
code for deriving route data, said route data being derived from said place position data; and
code for presenting said derived route data to a user of said device, wherein the code resides on a tangible medium.
